(19) United States
(12) Patent Application Publication
(10) Pub. No.: US 2026/0288722 A1
(43) Pub. Date: Sep. 24, 2026

(54) METHOD OF OPTIMIZING DATA PROCESSING, INFORMATION PROCESSING APPARATUS AND PROGRAM

(71) Applicant: NEC Corporation, Tokyo (JP)

(72) Inventors: Sourav SAHA, Tokyo (JP); Takuya ARAKI, Tokyo (JP)

(73) Assignee: NEC Corporation, Tokyo (JP)

(21) Appl. No.: 19/473,505

(22) PCT Filed: Apr. 20, 2023
(86) PCT No.: PCT/JP2023/015787

§ 371 Date: Oct. 8, 2025

(51) Int. Cl. G06F 16/2453

(52) U.S. Cl. CPC G06F 16/24537

(57) ABSTRACT

There is provided a method for optimizing data processing including a first operation which includes joining first and second tables each having common key, to generate a merged table, and projects value of project target column(s) of records in the merged table, the method comprising: replacing the first operation with a second operation, if the first operation satisfies first and second conditions, wherein, the first condition is that values of common key in the second table is unique, the second condition is that all the project target columns are included in the first table, and the second operation comprises; identifying a value(s) of common key of record(s) in the second table; and projecting value(s) of the column(s) of record(s) having the target value(s) in the common key column of the first table.

This application is a National Stage Entry of PCT/JP2023/015787 filed on Apr. 20, 2023, the contents of all of which are incorporated herein by reference, in their entirety.

### FIELD The present invention relates to a method of optimizing data processing, an information processing apparatus, and a program.

### BACKGROUND

In relational database, data of different entities are stored across different tables in order to normalize data (to optimize memory for data storage, avoid anomalies in data-handling etc.). Some Queries may use records stored across different tables to perform useful analysis. “JOIN” function (hereinafter simply expresses as JOIN) is used in such cases.

JOIN is a very frequently used operation in relational data analysis, training data preparation for Machine Learning algorithms by combining different input files etc. JOIN can be of different types. For example, SQL, one of the languages for controlling databases, has functions such as INNER-JOIN, OUTER-JOIN, etc. In the INNER JOIN, only keys found in both tables (i.e., common keys) will be considered for joining.

For example, in a relational database with a first table and a second table, there is a data processing that outputs (projects) values of target columns of records in the first table, where, in the records, the values of specific columns included only in the second table satisfy predetermined filtering conditions. When performing such a data processing, the first table and the second table are first merged with an INNER-JOIN to generate a merged table. From the merged table, records are extracted (filtered) whose values in the specific column satisfy the filtering conditions. Then, the values of the target columns of the filtered records are projected.

However, the computation cost of conventional JOIN operation is high. To reduce the computational cost, algorithms such as HASH-JOIN has been proposed, for example, which do not require process of sorting each table in advance (refer to Non-Patent Literature 1).
[NPLT 1] Zhou, J. (2009). Hash Join. In: LIU, L., OEZSU, M. T. (eds) “Encyclopedia of Database Systems”. Springer, Boston, MA, [online] [searched on Feb. 16, 2023], Internet <URL: https://doi.org/10.1007/978-0-387-39940-9_869>

### SUMMARY

The following analysis is made by the inventor of the present invention.

Among JOIN operations, HASH-JOIN with relatively low computational cost is restricted to cases where equivalence conditions are specified in the join condition. Even for HASH-JOIN, computational cost of join operation increases with the growth of the input table sizes.

In data analysis, after performing JOIN operation on two or more tables, the required columns are often extracted (projected) to perform useful analysis. In other words, JOIN and PROJECT are often used as a set, in data analysis.

Therefore, it is desirable to reduce computation cost of operation corresponding to JOIN-PROJECT, which joins two or more tables and extracts (or project) the required data.

In view of the foregoing, the present invention has been made. It is an object of the present invention to provide a technique that contributes to reducing computation cost in data processing (data analysis), in which two or more tables are joined and required data are extracted (or projected).

According to a first aspect of the present invention, there is provided a method for optimizing data processing including a first operation, the first operation including joining a first table and a second table, each having a common key, to generate a merged table, and projecting a value of one or more project target column(s) of records in the merged table, the method comprising:
determining by a computer whether content of the first operation satisfies a first condition and a second condition; and
replacing the first operation with a second operation, if the content of the first operation satisfies the first condition and the second condition, wherein,
the first condition is that each value of the common key in the second table is unique,
the second condition is that all of the project target columns are included in the first table, and
the second operation comprises;
   identifying a value(s) of the common key of record(s) in the second table, as a target value(s); and
   projecting value(s) of the project target column(s) of a record(s) having the target value(s) in the common key column of the first table.

According to a second aspect of the present invention, there is provided an information processing apparatus, comprising:
a query analysis part that analyzes queries to be processed and determines whether or not a first operation is included in the queries to be processed;
a query optimization part that performs a query optimization process; and a query execution part that executes the queries to be processed after optimization by the query optimization part, wherein
the first operation comprises joining a first table and a second table, each having a common key, to generate a merged table, and projects a value of one or more project target column(s) of records in the merged table,
the query optimization process comprises determining whether content of the first operation satisfies a first condition and a second condition, if the query analysis part determines that the queries to be processed include the first operation, and replacing the first operation in the queries to be processed with a second operation, if the content of the first operation satisfies the first condition and the second condition,
the first condition is that each value of the common key in the second table is unique,
the second condition is that all of the project target columns are included in the first table, and
the second operation comprises;
   identifying a value(s) of the common key of record(s) in the second table, as a target value(s); and
   projecting value(s) of the project target column(s) of a record(s) having the target value(s) in the common key column of the first table.

According to a third aspect of the present invention, there is provided a program causing a computer performing optimizing data processing including a first operation, the first operation including joining a first table and a second table, each having a common key, to generate a merged table, and projecting a value of one or more project target column(s) of records in the merged table, to execute steps of:
determining whether content of the first operation satisfies a first condition and a second condition; and
replacing the first operation with a second operation, if the content of the first operation satisfies the first condition and the second condition, wherein,
the first condition is that each value of the common key in the second
the second condition is that all of the project target columns are included in the first table,
the second operation comprises;
   identifying a value(s) of the common key of record(s) in the second table, as a target value(s); and
   projecting value(s) of the project target column(s) of a record(s) having the target value(s) in the common key column of the first table.

The above program may be stored in a computer-readable storage medium. The storage medium may be non-transient one such as a semiconductor memory, a hard disk, a magnetic recording medium, an optical recording medium, and the like. The present invention can be realized as a computer program product.

According to the present invention, it is possible to contribute to reducing computation cost in data processing, in which two or more tables are joined and required data are extracted (or projected).

### BRIEF DESCRIPTION OF DRAWINGS

FIG. 1A and FIG. 1B are diagrams illustrating examples of tables and a problem statement according to an example embodiment of the present invention.

FIG. 2A to FIG. 2C are diagrams illustrating an operation of a conventional data processing.

FIG. 3A to FIG. 3C are diagrams illustrating an operation of data processing according to the example embodiment of the present invention.

FIG. 4A and FIG. 4B are diagrams illustrating conditions for which the optimization process cannot be performed according to the example embodiment of the present invention.

FIG. 5A and FIG. 5B are a functional block diagram and a hardware configuration diagram of an information processing apparatus according to the example embodiment of the present invention.

FIG. 6 is a flowchart illustrating an example of a data analysis process according to the example embodiment of the present invention.

FIG. 7 is a flowchart illustrating an example of a query optimization process according to the example embodiment of the present invention.

FIG. 8 is a flowchart illustrating an example of an ISIN FILTER-PROJECT operation according to the example embodiment of the present invention.

FIG. 9A and FIG. 9B are diagrams illustrating an evaluation result.

### EXAMPLE EMBODIMENTS

First, an outline of an example embodiment of the present invention will be described with reference to drawings. In the following outline, various components are denoted by reference characters for the sake of convenience. That is, the following reference characters are merely used as examples to facilitate understanding of the present invention. Thus, the description of the outline is not meant to limit the present invention to the illustrated modes. An individual connection line between blocks in the drawings, etc. referred to in the following description signifies both one-way and two-way directions. An arrow schematically illustrates a principal signal (data) flow and does not exclude bidirectionality.

While a port or an interface is present at an input/output connection point of an individual block in the relevant drawings, illustration of the port or the interface is omitted. In addition, in the following description, “A and/or B” signifies A or B or A and B.

In the present example embodiment, an example will be described in which queries to be optimized, i.e., the queries for which the computational cost is to be reduced, is a JOIN-PROJECT in, for example, SQL language. In data analysis (data processing) according to the present example embodiment, JOIN-PROJECT operation in queries of data analysis program is replaced for optimization with an operation using ISIN method, if contents in the JOIN-PROJECT operation satisfy prescribed conditions. The operation with which the JOIN-PROJECT operation is to be replaced is hereinafter referred to as ISIN FILTER-PROJECT operation. Hereinafter, JOIN-PROJECT operation is simply referred to as JOIN-PROJECT and ISIN FILTER-PROJECT operation is simply referred to as ISIN FILTER-PROJECT.

The target tables for the data analysis shall be included in a relational database (RDB). That is, each table has a common key to make a relationship. Hereinafter, the rows of the tables are called records and the fields of the tables are called columns.

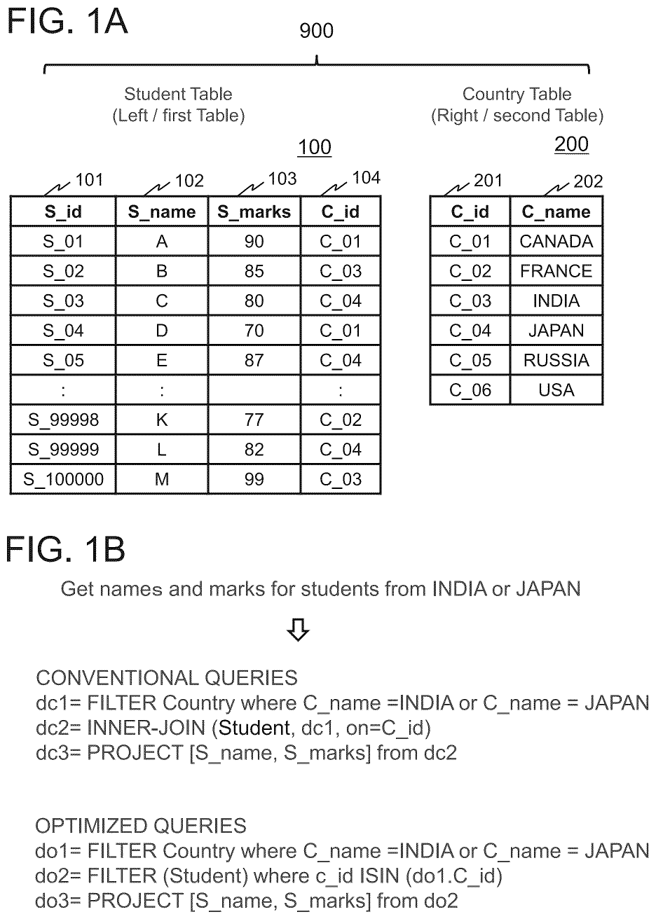

First, JOIN-PROJECT is explained with an example using the relational database (RDB) 900 shown in FIG. 1A. JOIN-PROJECT simply means joining two tables using a common key and project (extract) target column. That is to say JOIN-PROJECT is an operation that, for example, joins the first table (LEFT table) and the second table (RIGHT table) based on a common key to generate a joined table (merged table), and outputs (projects) the values of the specified columns (project target columns) of the joined table.

The JOIN-PROJECT will be described with a concrete example.

As illustrated in FIG. 1A, a relational database (RDB) 900 according to the present example embodiment is provided with a first table and a second table. The first table is a student table 100 which stores attributes and marks data of students from various countries of origin. The second table is a country table 200. The common key for both tables is a country code, which is described below.

The student table 100 is provided with columns of a student identification information (S_id)101, a student name (S_name)102, a mark (S_marks)103 and a country code (C_id)104, and is a table that stores a name, marks and a country code of origin of each student.

The country table 200 is provided with columns of a country code (C_id) 201 and country name (C_name) 202, and is a table that stores a name of a country corresponding to the country code.

In a system with such an RDB 900, for example, as illustrated in FIG. 1B, it supposes that a problem statement of “Get names and marks for students from INDIA or JAPAN” is given. This problem statement means that projecting values of the student name (S_name)102 and the marks (S marks)103 of the records of the student (S_id)101, whose country name (C_name) 202 is INDIA or JAPAN. A filtering condition should be “in records which have columns of the student name (S_name)102, the marks (S_marks)103 and the country name (C_name) 202, a value of the country name (C_name) 202 matching INDIA or JAPAN”.

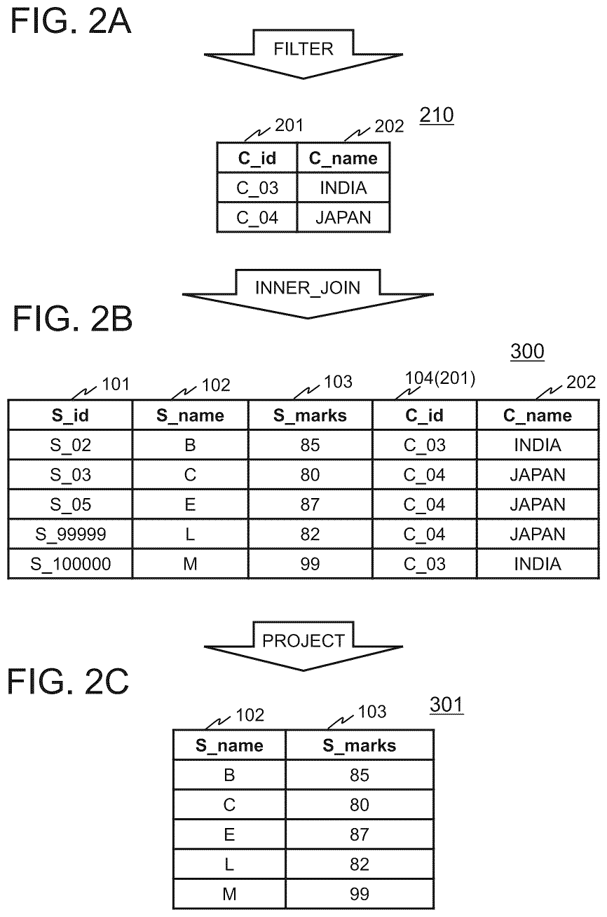

Following queries are created for the above problem statement, when using JOIN-PROJECT (conventional queries), as shown in FIG. 1B (CONVENTIONAL QUERIES).
dc1: filter records from the country table 200 where a value of the country name (C_name) 202 is INDIA or JAPAN (dc1=FILTER Country where C_name=INDIA or C_name=JAPAN). An example of a filtered country table 210 generated by this query is illustrated in FIG. 2A.
dc2: join the student table 100 and the filtered country table 210 using the common key (country code (C_id) 104 or 201) to create merged table 300 (dc2=INNER-JOIN (Student, dc1, on=C_id)). An example of the merged table 300 generated by this query is illustrated in FIG. 2B.
dc3: project values of the student name (S_name) 102 and marks (S_marks) 103 for each record in the merged table 300 (dc3=PROJECT [S_name, S_marks] from dc2). An example of a projected result 301 is illustrated in FIG. 2C.

In the present example embodiment, when such a problem statement is given, the JOIN-PROJECT (queries of dc2 and dc3 above) is replaced by the ISIN FILTER-PROJECT to optimize processes, if prescribed conditions are satisfied.

ISIN is a method that checks whether or not each record in a table has a particular value of a given list and returns a bool type (True or False) for each record. In other words, ISIN is a method that returns True for records having the particular value and False for all other records.

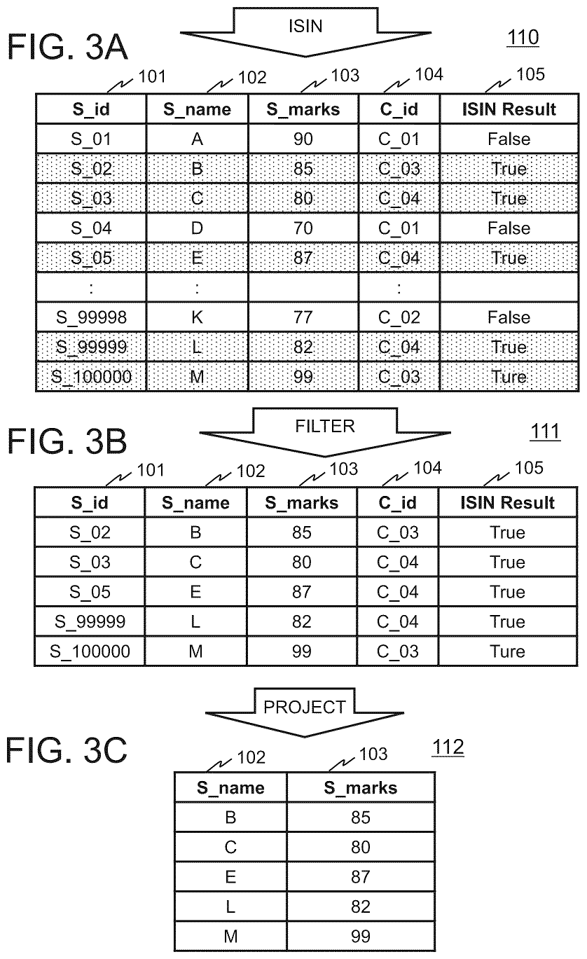

In the present example embodiment, when the above-mentioned problem statement of “Get names and marks for students from INDIA or JAPAN” is given, if the prescribed conditions are satisfied, following queries are created, as illustrated in FIG. 1B (OPTIMIZED QUERIES).
do1: filter records from the country table 200 where a value of the country name (C_name) 202 is INDIA or JAPAN. (do1=FILTER Country where C_name=INDIA or C_name=JAPAN). The filtered country table generated by this query is similar to the filtered country table 210 illustrated in FIG. 2A.
do2: check each record of student table 100 to evaluate whether it has any of values (C_03 and C_04) included in the filtered country table 210 (True/False determination) and filter (extract) records where determination result is true. (do2=FILTER (Student) where Student. C_id ISIN (do1.C_id)). An example of the determination result 110 and an example of a filtered result 111 are shown in FIG. 3A and FIG. 3B, respectively. The determination result 110 is a result of returning True if the value of the Student.C_id (104) is C_03 or C_04, and False otherwise, since the filtered country table 210 has only C_03 and C_04as values for the country code (C_id) 201.
do3: project values of the student name (S_name) 102 and marks (S_marks) 103 for each record in the filtered result 111. (do3=PROJECT [S_name, S_marks] from do2). An example of a projected result 112 is illustrated in FIG. 3C. Note that, the projected result 112 illustrated in FIG. 3C is the same as the projected result 301 obtained by JOIN-PROJECT illustrated in FIG. 2C.

In optimizing JOIN-PROJECT, a table and a filtering condition should satisfy certain conditions, as described above. The certain conditions are a first condition and a second condition.

The first condition is that values of the key column is unique in the second table. That is, in the example above, there are no duplicate values for the common key (country code (C_id) 201), in the filtered country table 210.

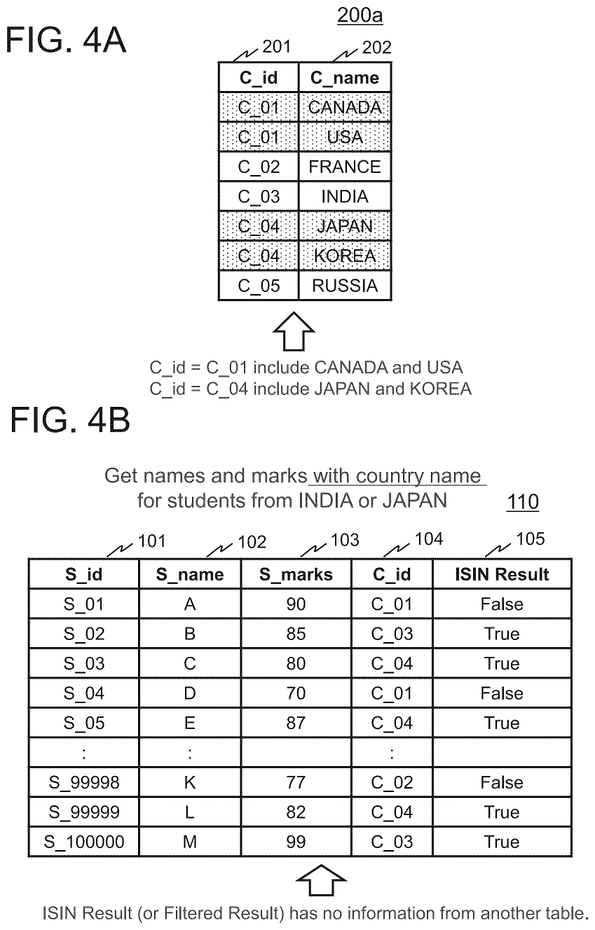

For example, the country table 200 illustrated in FIG. 1A satisfies the first condition. On the other hand, a country table 200a illustrated in FIG. 4A, for example, does not satisfy the first condition. In the country table 200a, the same value is assigned to the country code (C_id)201 for each region. As illustrated in FIG. 4A, in the country table 200a, C_01 is assigned to CANADA and USA, and C_04 to JAPAN and KOREA. In this case, the values of the common key (country code (C_id) 201), do not correspond one-to-one to the values of the country name (C_name) 202, so the True/False determination cannot be made on the values of the common key. If C_04 is determined to be True, not only the record of the student from JAPAN, but also the record of the student from KOREA is determined to be True.

The second condition is that all project target columns are included in the first table. The project target columns in the second condition are columns other than the common key (non-key column). In the example query created from the above problem statement, the project target columns are the student name (S_name) 102 and the marks (S_marks) 103, and both of which are included in student table 100.

On the other hand, for example, if the problem statement is “Get names and marks with country name for students from INDIA and JAPAN”, the project target columns are student name (S_name) 102, the marks (S_marks) 103 and the country name (C_name) 202. Therefore, in this case, the second condition is not satisfied. In the ISIN FLITER-PROJECT, only the first table (the student table 100 in the above example) is used to determine true or false, and the second table (the filtered country table 210) itself is not used in the determination process. As illustrated in FIG. 4B, the determination result 110 (and the filtered result 111) does not include information (values) for columns in the second table (the filtered country table 210), therefore. information from the other table cannot be projected.

An information processing apparatus 500 of the present example embodiment, which realizes the data analysis (data processing) described above, will be described.

### Functional Configuration

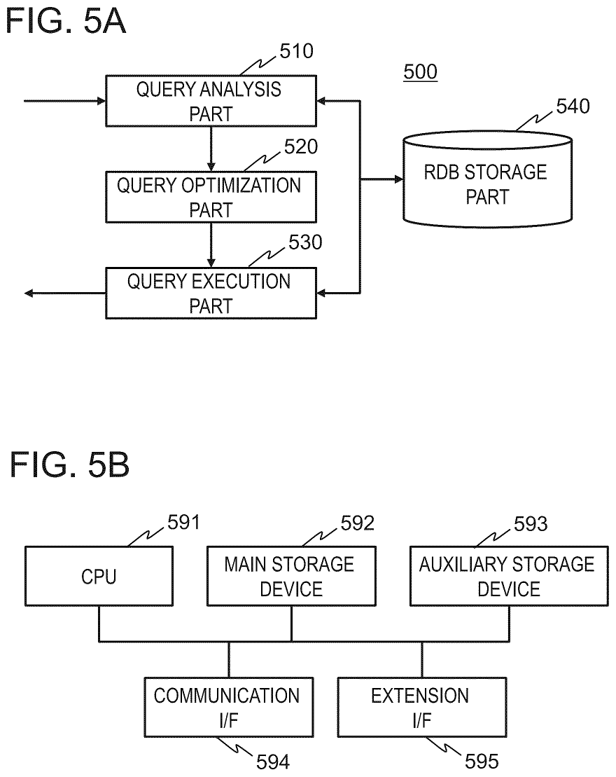

FIG. 5A is a block diagram for illustrating an example of a functional configuration of the information processing apparatus 500 according to the present example embodiment. Referring to FIG. 5A, the information processing apparatus 500 according to the present example embodiment is provided with a query analysis part 510, a query optimization part 520, a query execution part 530, and a RDB (Relational DataBase) storage part 540.

The RDB storage part 540 stores each table included in the RDB 900.

The query analysis part 510 loads tables required for processing from the tables stored in the RDB storage part 540 into the work area and analyzes coded program of the problem statement (queries generated from the problem statement) to determine whether it includes the JOIN-PROJECT. The query analysis part 510 notifies the query optimization part 520 of the determination result.

The query optimization part 520 performs a query optimization process.

If the query optimization part 520 receives a determination result that the JOIN-PROJECT is included in the queries, it analyzes a content of the process in the JOIN-PROJECT and determines whether it can be replaced by the ISIN FILTER-PROJECT. Here, the query optimization part 520 determines whether the content of the process in the JOIN-PROJECT satisfies the first and second conditions above. If the query optimization part 520 determines that the content of the process in the JOIN-PROJECT satisfies both the first and second conditions, i. e., values of the common key of all records in the second table (the filtered country table 210), are unique and all project target columns are included in the first table, it decides that a replacement is possible.

The query optimization part 520 then replaces the JOIN-PROJECT in the queries with the ISIN FILTER-PROJECT, if it determines that they can be replaced. If the query optimization part 520 does not decide that replacement is possible, or if it receives a determination result from the query analysis part 510 that JOIN-PROJECT is not included, no replacement is performed.

The query execution part 530 executes the queries after the query optimization and project the results.

### Data Analysis Process

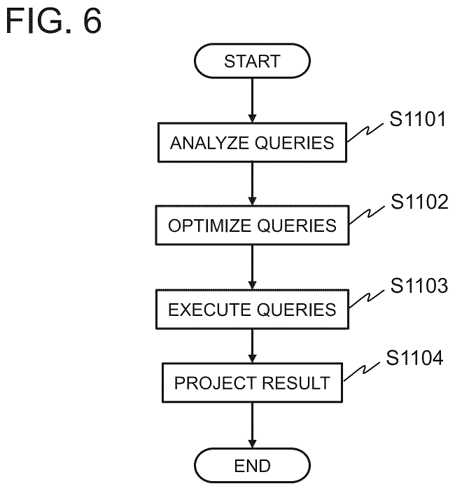

The flow of the data analysis process by the information processing apparatus 500 according to the present example embodiment is described. FIG. 6 is a flowchart illustrating an example of a data analysis process performed by the information processing apparatus 500 according to the present example embodiment. Here, it is assumed that the queries (program codes) have been generated beforehand from the given problem statement and the required databases have been loaded.

The query analysis part 510 analyzes the queries (step S1101). Here, the query analysis part 510 determines whether or not the JOIN-PROJECT is included in the queries and notifies the query optimization part 520 of the determination result.

The query optimization part 520 performs query optimization process (step S1102). Details of the query optimization process are described below.

Then, the query execution part 530 executes the queries (step S1103), projected the result (step S1104), and terminates the process.

### Query Optimization Process

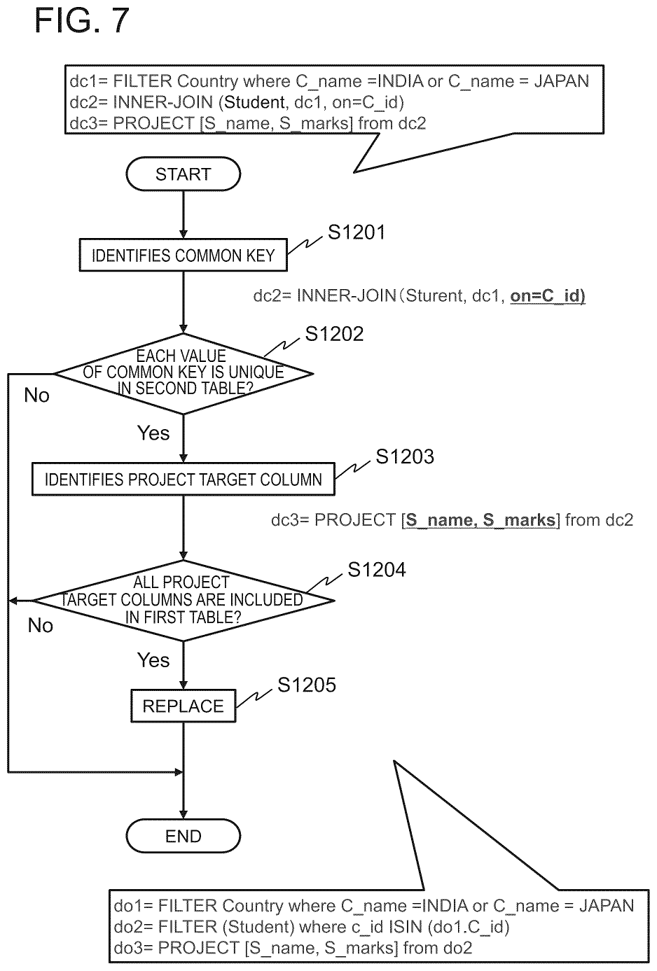

The flow of the query optimization process by the query optimization part 520, when it receives a determination result from the query analysis part 510 that a JOIN-PROJECT is included in the queries, is described in FIG. 7. The queries to be optimized is the JOIN-PROJECT, described in FIG. 1B as CONVENTIONAL QUERIES. The first and second tables are the student table 100 and the filtered country table 210 illustrated in FIG. 1A and FIG. 2A, respectively.

The query optimization part 520 first determines whether the JOIN-PROJECT detected by the query analysis part 510 satisfies the first condition.

The query optimization part 520 identifies a common key for the detected JOIN-PROJECT (step S1201). Here, the query optimization part 520 refers to and identifies the description of the common key of the INNER-JOIN query. That is, C_id in “dc2=INNER-JOIN (Student, dc1, on=C_id)”.

The query optimization part 520 then determines whether each value of the common key is unique in the second table (filtered country table 210) (step S1202).

Next, if each value of the common key is unique (S1202; Yes), the query optimization part 520 determines whether the detected JOIN-PROJECT satisfies the second condition.

The query optimization part 520 identifies the project target column of the detected JOIN-PROJECT (step S1203). Here, the query optimization part 520 refers to and identifies the description of the project target column of the PROJECT query. That is, S_name and S_marks in “dc3=PROJECT [S_name, S_marks] from dc2”

The query optimization part 520 then determines whether all the project target columns are included in the first table (step S1204).

If all the project target columns are included in the first table (S1204; Yes), the query optimization part 520 replaces JOIN-PROJECT with ISIN FILTER-PROJECT in the queries (step S1205) and terminates the optimization process. If, in step S1202, each value of the common key of the second table is not unique (S1202; No), or if, in step S1204, all the project target columns are not included in the first table (S1204; No), the query optimization part 520 does not replace JOIN-PROJECT and terminates the optimization process. The process of step S1204 is performed when the number of project target columns is 2 or more. If the number of project target columns is 1, step S1204 is not performed, and the process moves to step S1205.

### ISIN FILTER-PROJECT Operation

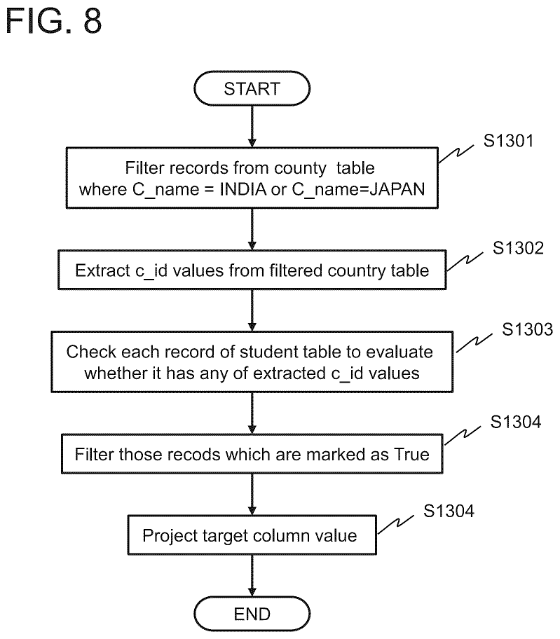

A flow of ISIN FILTER-PROJECT operation performed by the query execution part 530 is described briefly. FIG. 8 is a flowchart illustrating an example of ISIN FILTER-PROJECT operation. The following is the flow of the process when executing the queries below, created for the problem statement of “Get names and marks for students from INDIA and JAPAN”.
do1=FILTER Country where C_name=INDIA or C_name=JAPAN
do2=FILTER (Student) where Student.C_id ISIN (do1.C_id)
do3=PROJECT [S_name, S_marks] from do2

The query execution part 530 filters records satisfying the filtering condition from the country table 200 to generate the filtered country table 210 illustrated in FIG. 2A. That is, the query execution part 530 filters records where a value of the country name (C_name) 202 is INDIA or JAPAN (step S1301).

Then, the query execution part 530 extracts values of the common key (C_id), as a target value(s), from the filtered country table 210 (step S1302).

The query execution part 530 checks each record of the student table 100 to evaluate whether it has (any of) the target value(s) in Student.C_id column 104 (step S1303). Here, if the record has the target value(s), the query execution part 530 marks it as True, otherwise, the query execution part 530 marks it as False, and the determination result 110 illustrated in FIG. 3A is obtained.

The query execution part 530 then filters the records marked as True (step S1304) and obtains the filtered result 111 illustrated in FIG. 3B.

The query execution part 530 projects values of the project target column from the filtered result 111 (step S1305), obtains the projected result 112 illustrated in FIG. 3C, and terminates process.

### Hardware Configuration

The information processing apparatus 500 of the present example embodiment is realized by a so-called general-purpose information processing apparatus (computer) and, for example, has a configuration as exemplified in FIG. 5B.

The information processing apparatus 500 of the present example embodiment is, for example, provided with a CPU (Central Processing Unit) 591, a main storage device (memory) 592, an auxiliary storage device 593, a communication I/F (interface) 594, and an extension I/F 595 which are interconnected by an internal bus as illustrated in FIG. 5B.

The CPU 591, for example, loads the program stored in the auxiliary storage device 593 into the main storage device 592 and executes it to realize each of the above functions and to control the entire information processing apparatus 500. One or more processors such as a micro processing unit (MPU) may be used instead of the CPU 591.

The main storage device 592 is a memory such as RAM (Random Access Memory). The main storage device 592 is a work area for the CPU 591 to process the programs, etc. executed by the information processing apparatus 500.

The auxiliary storage device 593 stores various programs executed by the information processing apparatus 500. In the present example embodiment, the auxiliary storage device 593 also stores each table (student table 100 and country table 200) that are included in the RDB 900.

The above functions of the information processing apparatus 500 in the present example embodiment are realized by the CPU 591 loading and executing the program stored in the auxiliary storage device 593 into the main storage device 592. Data generated during processing is stored in the main storage device 592 or the auxiliary storage device 593.

The auxiliary storage device 593 has, for example, a ROM (Read Only Memory), HDD (Hard Disk Drive), SSD (Solid State Drive), etc. Auxiliary storage device 593 may have a storage medium such as a flexible disk, hard disk, optical disk, CD-ROM, CD-R, magnetic tape, non-volatile memory card, DVD, etc.

The program stored in the auxiliary storage device 593 can be provided as a program product recorded on a non-transitory computer-readable storage medium. The auxiliary storage device 593 can be used to store various programs recorded in the non-transitory computer readable storage medium in mid and long term.

The communication I/F 594 transmits and receives signals and data by wired or wireless means. The information processing apparatus 500 may be provided with, for example, a NIC (Network Interface Card) as the communication I/F 594.

The extension I/F 595 is an interface that connects an output device such as a display device and an input device. The display device is, for example, an LCD monitor. The input device is a device that accepts user operations, such as a keyboard or mouse, for example. In the present example embodiment, for example, inputted queries are accepted via the input device, and processing results are displayed on the display device.

It should be noted that the hardware configuration illustrated in FIG. 5B is not intended to limit the hardware configuration of the information processing apparatus 500. The information processing apparatus 500 may include a hardware(s) not illustrated in FIG. 5B.

It is to be noted that programs which realize each function of the information processing apparatus 500 can be recorded on a computer-readable storage medium. The storage medium can be non-transient one, such as a semiconductor memory, a hard disk, a magnetic recording medium, an optical recording medium, and so on. The present invention can be implemented as a computer program product.

As explained above, the present example embodiment of the information processing apparatus 500 replaces the commonly used JOIN-PROJECT, as a process for joining two tables and filtering (extracting) necessary data, with ISIN FILTER-PROJECT whose computation cost is lower than JOIN-PROJECT, if the prescribed conditions are satisfied. The replacement is made if contents of JOIN-PROJECT satisfy the first and second conditions. The first condition is that each value of the common key in the second table is unique. The second condition is that all project target columns are columns of the first table.

As described above, ISIN simply involves some if-checks against the target values for each record of the first table. Thus, it is very lighter in comparison to HASH-JOIN operation. Hence ISIN FILTER-PROJECT will be much faster than JOIN-PROJECT. According to the present example embodiment, it is possible to contribute to reducing computation cost in data processing, in which two or more tables are joined and required data are projected.

### Modified Example 1

In the above example embodiment and modified examples, each table is stored in the information processing apparatus 500, but is not limited to this. For example, each table may be stored in a network storage, such as NAS (Network Attached Storage) or SAN (Storage Area Network). Each table may be stored in different storages.

### Modified Example 2

In the above embodiment and modified examples, each table is described as being included in the RDB, but is not limited to this.

Although, in a plurality of flowcharts used in the above description, a plurality of processes is described in sequence, an execution order of processes performed in each example embodiment and modified examples is not limited by an order of description thereof. In each example embodiment and modified examples, it is possible to change an order of processes illustrated in the drawings within an extent that will not offer any problem to content, for example, executing each

### Experimental Study

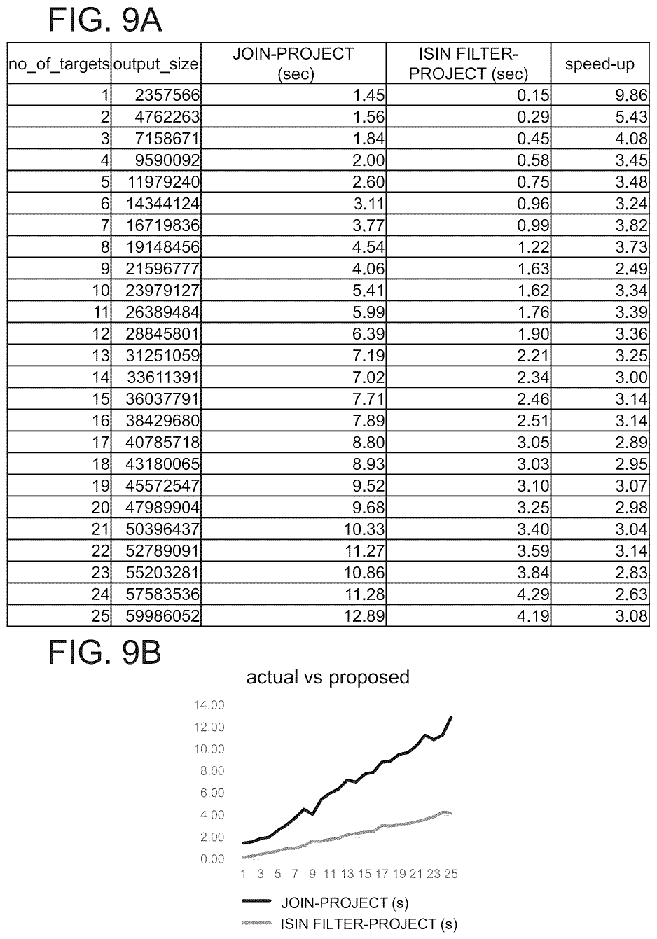

Evaluation result of JOIN-PROJECT and ISIN FILTER-PROJECT is presented in FIG. 9A and FIG. 9B. For the evaluation, we have used lineitem (size: 59986052.), supplier (size: 100000) and nation (size: 25) tables from the TPC-H benchmark with Scale Factor 10. TPC-H is a decision support benchmark, which consists of a suite of business-oriented ad hoc queries with concurrent data modifications. As illustrated in FIG. 9A and FIG. 9B, ISIN FILTER-PROJECT is up to 9-times faster than JOIN-PROJECT, with an average speed-up of around 3.5 times.

A part or a whole of the above-mentioned example embodiments may be described as, but not limited to, the following supplementary notes.

### Supplementary Note 1

A method for optimizing data processing including a first operation, the first operation including joining a first table and a second table, each having a common key, to generate a merged table, and projecting a value of one or more project target column(s) of records in the merged table, the method comprising:
determining by a computer whether content of the first operation satisfies a first condition and a second condition; and
replacing the first operation with a second operation, if the content of the first operation satisfies the first condition and the second condition, wherein,
the first condition is that each value of the common key in the second table is unique,
the second condition is that all of the project target columns are included in the first table, and
the second operation comprises;
   identifying a value(s) of the common key of record(s) in the second table, as a target value(s); and
   projecting value(s) of the project target column(s) of a record(s) having the target value(s) in the common key column of the first table.

### Supplementary Note 2

The method for optimizing data processing according to the Supplementary Note 1, wherein,
in the second operation, the value(s) of the project target column(s) of the record(s) in the first table, for which a value of the common key is the target value, is projected.

### Supplementary Note 3

The method for optimizing data processing according to the Supplementary Note 1 or 2, wherein,
the computer performs the first operation, if at least one of the first condition and the second condition is not satisfied.

### Supplementary Note 4

The method for optimizing data processing according to any one of Supplementary Notes 1 to 3, wherein,
the second operation is ISIN FILTER-PROJECT operation.

### Supplementary Note 5

The method for optimizing data processing according to any one of Supplementary Notes 1 to 4, wherein,
the first operation is JOIN-PROJECT operation.

### Supplementary Note 6

An information processing apparatus, comprising:
a query analysis part that analyzes queries to be processed and determines whether or not a first operation is included in the queries to be processed;
a query optimization part that performs a query optimization process; and a query execution part that executes the queries to be processed after optimization by the query optimization part, wherein
the first operation comprises joining a first table and a second table, each having a common key, to generate a merged table, and projects a value of one or more project target column(s) of records in the merged table,
the query optimization process comprises determining whether content of the first operation satisfies a first condition and a second condition, if the query analysis part determines that the queries to be processed include the first operation, and replacing the first operation in the queries to be processed with a second operation, if the content of the first operation satisfies the first condition and the second condition,
the first condition is that each value of the common key in the second table is unique,
the second condition is that all of the project target columns are included in the first table, and
the second operation comprises;
   identifying a value(s) of the common key of record(s) in the second table, as a target value(s); and
   projecting value(s) of the project target column(s) of a record(s) having the target value(s) in the common key column of the first table.

### Supplementary Note 7

A program causing a computer performing optimizing data processing including a first operation, the first operation including joining a first table and a second table, each having a common key, to generate a merged table, and projecting a value of one or more project target column(s) of records in the merged table, to execute steps of:
determining whether content of the first operation satisfies a first condition and a second condition; and
replacing the first operation with a second operation, if the content of the first operation satisfies the first condition and the second condition, wherein,
the first condition is that each value of the common key in the second table is unique,
the second condition is that all of the project target columns are included in the first table,
the second operation comprises;
   identifying a value(s) of the common key of record(s) in the second table, as a target value(s); and
   projecting value(s) of the project target column(s) of a record(s) having the target value(s) in the common key column of the first table.
The above modes 6 and 7 can be expanded in the same way as mode 1 is expanded to modes 2 to 5.

It should be noted that, each disclosure of the NPLs cited above is incorporated herein by reference thereto. It is to be noted that it is possible to modify or adjust the example embodiments or examples within the whole disclosure of the present invention (including the Claims) and based on the basic technical concept thereof. Further, it is possible to variously combine or select (or partially delete) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without specific recital thereof. For example, the configurations illustrated in the drawings have been used only as examples to facilitate understanding of the present invention. That is, the present invention is not limited to the configurations illustrated in the drawings.
100: student table
101: student identification information (S_id)
102: student name (S_name)
103: marks (S_marks)
104: country code (C_id)
110: determination result
111: filtered result
112: projected result
201: country code (C_id)
202; country name (C_name)
200a: country table
210: filtered country table
300: merged table
301: projected result
500: information processing apparatus
510: query analysis part
520: query optimization part
530: query execution part
540: RDB storage part
591: CPU
592: main storage device
593: auxiliary storage device
594: communication I/F
595: extension I/F
900: relational database (RDB)

What is claimed is:

1. A method for optimizing data processing including a first operation, the first operation including joining a first table and a second table, each having a common key, to generate a merged table, and projecting a value of one or more project target column(s) of records in the merged table, the method comprising:
determining, by a computer, whether content of the first operation satisfies a first condition and a second condition; and
replacing, by the computer, the first operation with a second operation, if the content of the first operation satisfies the first condition and the second condition, wherein,
the first condition is that each value of the common key in the second table is unique,
the second condition is that all of the project target columns are included in the first table, and
the second operation comprises;
identifying a value(s) of the common key of record(s) in the second table, as a target value(s); and
projecting value(s) of the project target column(s) of a record(s) having the target value(s) in the common key column of the first table.

2. The method for optimizing data processing according to claim 1, wherein,
in the second operation, the value(s) of the project target column(s) of the record(s) in the first table, for which a value of the common key is the target value, is projected.

3. The method for optimizing data processing according to claim 1, wherein,
the computer performs the first operation, if at least one of the first condition and the second condition is not satisfied.

4. The method for optimizing data processing according to claim 1, wherein,
the second operation is ISIN FILTER-PROJECT operation.

5. The method for optimizing data processing according to claim 1, wherein,
the first operation is JOIN-PROJECT operation.

6. An information processing apparatus, comprising:
at least a processor; and
a memory in circuit communication with the processor,
wherein the processor is configured to execute program instructions stored in the memory to implement:
a query analysis part that analyzes queries to be processed and determines whether or not a first operation is included in the queries to be processed;
a query optimization part that performs a query optimization process; and
a query execution part that executes the queries to be processed after optimization by the query optimization part, wherein
the first operation comprises joining a first table and a second table, each having a common key, to generate a merged table, and projects a value of one or more project target column(s) of records in the merged table,
the query optimization process comprises determining whether content of the first operation satisfies a first condition and a second condition, if the query analysis part determines that the queries to be processed include the first operation, and replacing the first operation in the queries to be processed with a second operation, if the content of the first operation satisfies the first condition and the second condition,
the first condition is that each value of the common key in the second table is unique,
the second condition is that all of the project target columns are included in the first table, and
the second operation comprises;
identifying a value(s) of the common key of record(s) in the second table, as a target value(s); and
projecting value(s) of the project target column(s) of a record(s) having the target value(s) in the common key column of the first table.

7. A non-transitory computer-readable medium storing a A program causing a computer performing optimizing data processing including a first operation, the first operation including joining a first table and a second table, each having a common key, to generate a merged table, and projecting a value of one or more project target column(s) of records in the merged table, to execute:
determining, by the computer, whether content of the first operation satisfies a first condition and a second condition; and
replacing, by the computer, the first operation with a second operation, if the content of the first operation satisfies the first condition and the second condition, wherein,
the first condition is that each value of the common key in the second table is unique,
the second condition is that all of the project target columns are included in the first table,
the second operation comprises;
identifying a value(s) of the common key of record(s) in the second table, as a target value(s); and
projecting value(s) of the project target column(s) of a record(s) having the target value(s) in the common key column of the first table.

8. The method for optimizing data processing according to claim 2, wherein,
the computer performs the first operation, if at least one of the first condition and the second condition is not satisfied.

9. The method for optimizing data processing according to claim 2, wherein,
the second operation is ISIN FILTER-PROJECT operation.

10. The method for optimizing data processing according to claim 3, wherein,
the second operation is ISIN FILTER-PROJECT operation.

11. The method for optimizing data processing according to claim 2, wherein,
the first operation is JOIN-PROJECT operation.

12. The method for optimizing data processing according to claim 3, wherein,
the first operation is JOIN-PROJECT operation.

13. The method for optimizing data processing according to claim 4, wherein,
the first operation is JOIN-PROJECT operation.

14. The information processing apparatus according to claim 6, wherein,
in the second operation, the value(s) of the project target column(s) of the record(s) in the first table, for which a value of the common key is the target value, is projected.

15. The information processing apparatus according to claim 6, wherein,
the query execution part performs the first operation, if at least one of the first condition and the second condition is not satisfied.

16. The information processing apparatus according to claim 6, wherein,
the second operation is ISIN FILTER-PROJECT operation.

17. The information processing apparatus according to claim 6, wherein,
the first operation is JOIN-PROJECT operation.

18. The information processing apparatus according to claim 14, wherein,
the query execution part performs the first operation, if at least one of the first condition and the second condition is not satisfied.

19. The information processing apparatus according to claim 14, wherein,
the second operation is ISIN FILTER-PROJECT operation.

20. The information processing apparatus according to claim 14, wherein,
the first operation is JOIN-PROJECT operation.
